(19) United States
(12) Patent Application Publication
(10) Pub. No.: US 2007/0227462 A1
(43) Pub. Date: Oct. 4, 2007

(54) Pet window for a fence or gate

(76) Inventor: Blane Huff, Eric, CO (US)

Correspondence Address: BUHLER ASSOCIATES;BUHLER, KIRK A., 1101 CALIFORNIA AVE., SUITE 208, CORONA, CA, 92881, US

(21) Appl. No.: 11/396,038

(22) Filed: Apr. 3, 2006

(51) Int. Cl. A01K 1/03

(52) U.S. Cl. 119/484

(57) ABSTRACT

A window that is installed on a fence or gate is disclosed. The window is installed in an existing fence or gate and allows an animal to look through the fence or gate at people cars or other objects that are on the other side of the fence or gate. The window is fabricated from a single clear material and is printed marked or painted with a border that simulates a frame and or roof structure. Installation of the window requires removing a section of an existing gate or fence and installing the window over the removed section. Since the window is made from a closed surface material sound from the animal such as barking is restricted from transmitting through the window, and also prevents children from sticking their fingers or food through the window.

### FIELD OF THE INVENTION

This invention relates to a pet window for installation in a fence. More particularly, the present invention relates to a window fabricated from a single plate of material where a portion of the window is clear and a portion of the window is painted or coated to simulate a wooden frame including a roof.

### BACKGROUND OF THE INVENTION

Windows are generally used in houses or walls to view what is outside. Windows constructed for these purposes are designed for installation in a wall or door when the door, house or building is being constructed. An example of a window that is placed through a door is found in U.S. Pat. No. 4,947,597 issued to Simson on Aug. 14, 1990. This patent is for a window mounting assembly that fits into a hollow or solid core door. It provides two panes of glass to allow for insulation and viewing. The mounting structure of the window sandwiches the window into the door. This window is not mountable on to only one side of a fence or gate. The frame of the window is not cosmetically treated to give the appearance of a wood frame or a roof structure.

Animal access doors are generally made using a flexible flap that an animal can use to pass through. Examples of this type of animal door are found in U.S. Pat. No. 5,117,890 issued to Taylor et al. on Jun. 2, 1992 and U.S. Pat. No. 5,535,804 issued to Guest on Jul. 16, 1996. Both these patents provide a flap that allows passage of an animal through the door. The door surface is a solid or mesh surface that allows the animal as well as sound to transmit through the door surface. These products do not restrict passage of a pet. These products sandwich the door in an existing door. The frame of the window is not cosmetically treated to give the appearance of a wood frame or a roof structure.

Some windows have been made that provide an open screen or wire window that are placed in or through a fence or gate to allow an animal to look through the fence or gate. Examples of this type of screened windows are found in U.S. Pat. No. 4,856,575 issued to Wells on Aug. 15, 1989 and U.S. Pat. No. 6,581,668 issued to Oakley on Jun. 24, 2003. Both these patents provide an open screen that a person can pass food through or a child can place their finger(s) through. The window surface is made from a wire mesh that allows sound to transmit through the window as well as providing wire that a pet can chew through. The frame of the window is not cosmetically treated to give the appearance of a wood frame or a roof

What is needed is a viewing door for a gate or fence that an animal can look through without the possibility that a child can place a finger or food through the window. The proposed pet window provides this solution by providing a closed window with cosmetic detailing that allows the pet to view outside the gate or fence, protects people and children, provides a sound barrier, and is cosmetically pleasing.

### BRIEF SUMMARY OF THE INVENTION

It is an object of the pet window to provide a window that can be placed on an existing fence or gate that allows a pet to look through the window to see who or what is on the other side of the window.

It is another object of the pet window to provide a window made from a transparent material that allows a pet to look through the window to view what is on the other side of the window. An additional benefit from the clear window is to allow people on the outside of the gate or fence to view the presence of an animal that is behind the gate or fence prior to opening the gate or fence.

It is another object of the pet window to provide a window that is fabricated from a single piece of material that is painted, printed, stained or otherwise treated to give the appearance of wood or other material as a frame for the window.

It is another object of the pet window to provide a pet window that is solid in construction to minimize sound made from a pet that is located behind the window.

It is another object of the pet window to provide a window that improves the safety of people placing fingers through the window as well as preventing people from placing food or other objects through the window that could be harmful to the pet.

It is another object of the pet window to provide a window with raised and or depressed relief surface to give the appearance of shingles, roof structure or other cosmetic details.

It is still another object of the pet window to provide a viewing portal that minimizes the potential for a pet from chewing through the window or causing harm to the animal if they should chew through the material the window is constructed from. Pet of different sizes have different size mouths that allow them to chew or push through wire or mesh fences, dividers or windows.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 shows an isometric view of the pet window located on a fence or gate.

FIG. 2 shows an isometric sectional view of the pet window.

FIG. 3 shows an assembly view of the pet window being installed on a wooden gate.

### DETAILED DESCRIPTION

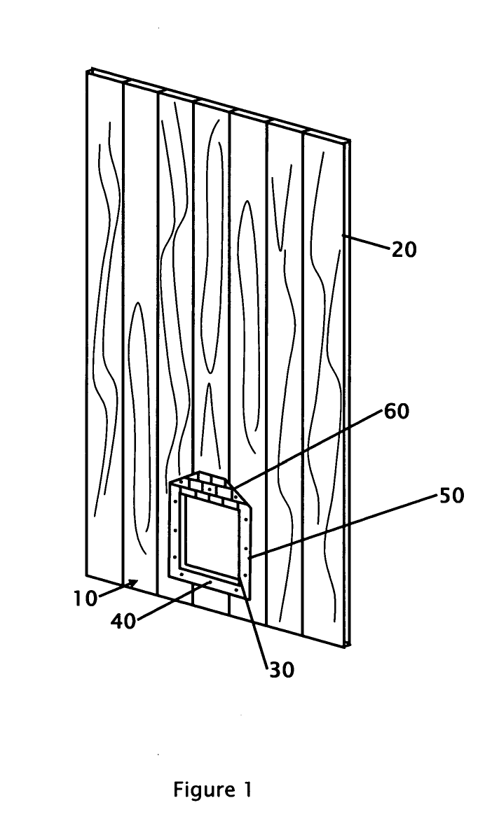

FIG. 1 shows an isometric view of the pet window 10 located on a fence or gate. The words fence and gate are used as examples of solid or semi-solid structures that block the view of a pet that is located on one side of the gate or fence. This figure represents the preferred embodiment of the window mounted in a gate or fence 20 and placed at a height sufficient to allow a pet to look through the window to view what exists on the other side of the window. In the preferred embodiment the entire window is molded as a single unit. While in the preferred embodiment the manufacturing process is from molding, it is contemplated that the window can also be cast, or machined or stamped from a flat plate of transparent plastic. The preferred material of the window is a rigid transparent material such as polycarbonate, but other materials are contemplated including but not limited to ABS, PVC, polyethylene, Lexan, acrylic, glass, plastic or resin. The molded part is molded from a transparent or clear material where it is completely transparent. The molding process is ideal for producing the final part because details such as a roof 60 and or simulated wooden side members 50 can be molded into the window to provide a more stylized appearance. The window is shown in the shape of a house, but could be in a variety of shapes including but not limited to square, rectangular, round, oval, polygonal, elliptical, pentagonal or hexagonal.

The roof and siding can be painted, printed, embossed or molded to further enhance the cosmetic pattern on the window. It is also contemplated that the window includes a paint kit to allow the user to customize the window to match the fence or gate. While the outside of the window is colored to simulate a roof or siding, the central area 30 is left clear to allow a pet to view what is on the other side of the window. The window can be placed on one or both sides of the gate or fence. Because the window is essentially flat in shape the possibility that a pet can chew on the window is minimized. The window is secured onto the gate or fence with hardware 40 that holds the window onto the gate or fence. In the preferred embodiment the hardware is threaded fasteners that pass through the window and screw into the gate or fence. In another contemplated embodiment the window has molded raised standoffs, and the threaded fasteners are passed through the back of the fence or gate and pull the window into the fence or gate. If separate window members are placed on opposite side of a fence or gate the hardware is passed through one window, through the fence, and then through the second window before being secured with a nut or other fastener. In another contemplated installation the windows placed on opposite sides of the fence are offset slightly to allow fasteners located on each side of the fence to pass by each other.

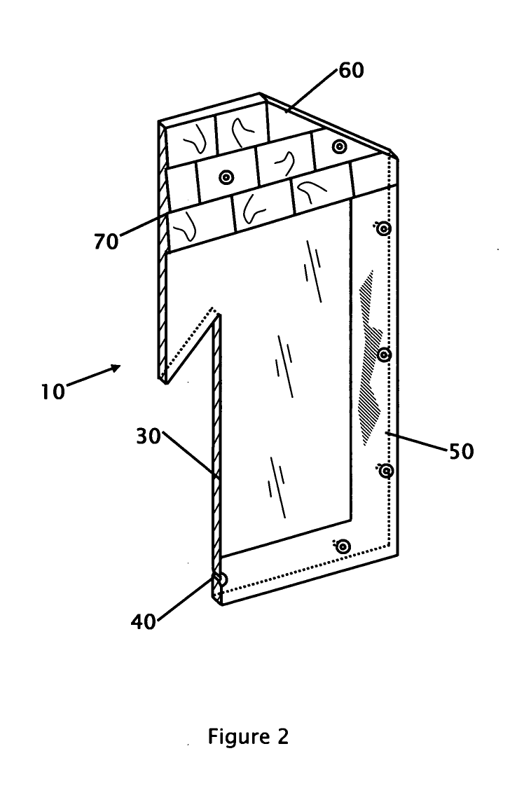

FIG. 2 shows an isometric sectional view of the pet window 10. This figure shows that the window is molded as a single unit without requiring multiple additional backing components. This provides a less expensive window with a simpler method of installation. The entire window can be molded in clear material with raised detailing for simulated shingles 60 and wood siding 50 formed in the molding process. Simulated shingles or roof can extend 70 a significant distance from the planar surface of the window to provide shade and or protection from the rain when the pet is looking through the window. It is contemplated that the window is molded with a tinted or colored material that provides shade or partial blocking or filtering of light transmission through the window.

Coloring on these details are added on the top side, back, side or on both sides. The central portion of the window 30 allows a pet to look through the window to view what is on the other side of the gate or fence. In addition to the ability of the pet to view what is on the other side of the gate or fence, the window also allows a person the see if an animal such as a dog is present on the other side of the fence without having to look over the fence or open the fence. A cross section of a mounting hole 40 is shown in the cross sectional view showing that the hole exists through the window and includes a countersunk, counter bored or recessed for the head of a mounting screw. In another contemplated embodiment the hole is replaced with molded raised standoffs, and the threaded fasteners are passed through the back of the fence or gate and pull the window into the fence or gate. It is contemplated that one or more through holes can be molded or drilled through the window to allow some air passage through the window. It is contemplated that these holes be sufficiently large enough to allow for a pet (dog) to smell what or who is on the other side of the window, but sufficiently small enough to prevent a person from passing food, fingers or other object through the holes that could cause harm to the pet or to the person.

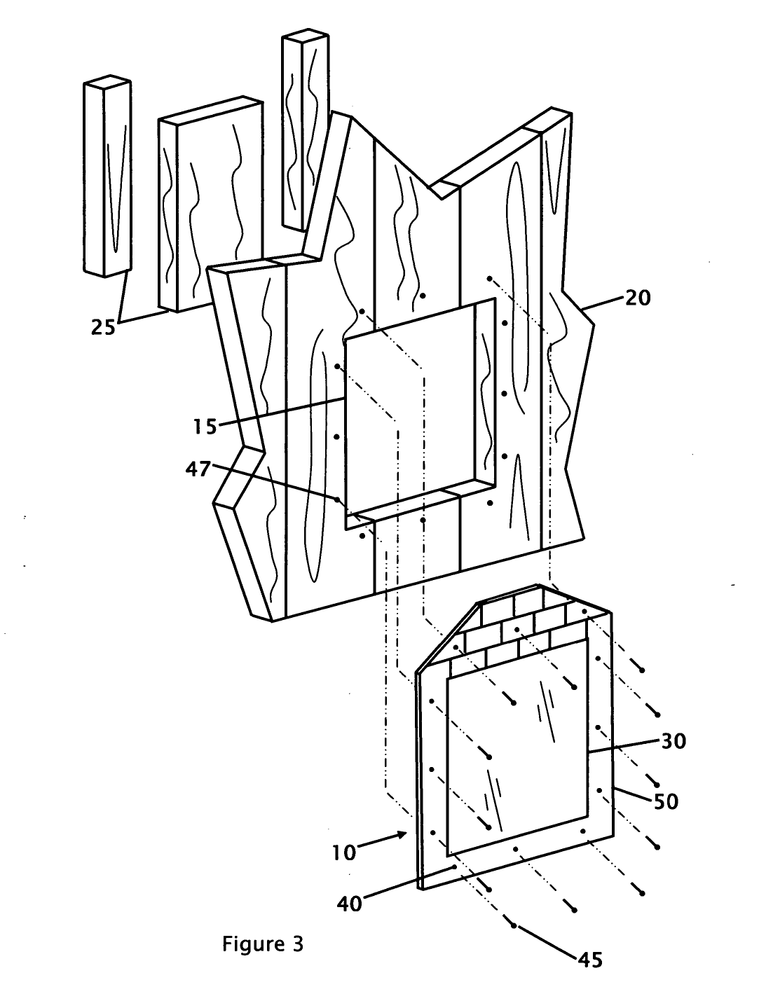

FIG. 3 shows an assembly view of the pet window 10 being installed on a wooden gate 20. Animals exist in various sizes and heights. It is contemplated that a locating aid be included with the window to guide the installer to a suggested installation height of the window. A pattern is also included to provide guidance for the removal of some of the gate 20 as well as location of any holes that may need to be drilled. Once the location and size of the opening in the gate 20 is determined the gate is cut 15 and the section(s) of the gate 25 are removed. The location of holes 47 can be marked and drilled into the gate to allow a guide for placement of the screws. The window 10 is brought into position on the gate and located on the gate 20 to allow the window portion 30 to exist in the removed opening 15. The painted and or embossed surrounding surface of the window 50 provides some structural strength to the gate where the material has been removed. The hardware 45 is then placed through the holes 40 in the window 10 and the window is secured onto the gate. It is contemplated that a window can be placed on each side of the gate creating an air pocket in the gate between the two windows.

Thus, specific embodiments and applications for a window for installation on a gate or fence have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A window for a gate comprising:
A transparent planar plate structure having a transparent viewing area, a border area, and a plurality of holes in the border area of the planer plate structure for mounting said transparent planer plate structure on a fence or gate.

2. The window for a gate from claim 1 where the border area includes a printed, painted, embossed or molded cosmetic pattern on the transparent planar surface to provide cosmetic appearance of wood and or shingles.

3. The window for a gate from claim 1 that further includes raised and or depressed detailing to provide the appearance of wood or shingles.

4. The window for a gate from claim 1 that further includes an extended roof or lip feature over a transparent window feature to provide shade and or rain protection.

5. The window for a gate from claim 1 that further includes fastening hardware for attaching the transparent planar plate structure on a fence or gate.

6. The window for a gate from claim 1 where the plurality of holes include countersunk, counter bored or recessed holes.

7. The window for a gate from claim 1 that further includes stand offs formed in the transparent planar plate structure for retaining fastening hardware.

8. The window for a gate from claim 1 that further includes a pattern to identify the material that is removed from the fence or gate where the transparent planar plate structure is mounted on the fence or gate.

9. The window for a gate from claim 1 that further includes a pattern to identify where holes are needed in the fence or gate where the transparent planar plate structure is mounted on the fence or gate.

10. The window for a gate from claim 1 that further includes at least one hole in the transparent planar plate structure for ventilation.

11. The window for a gate from claim 1 that further provides structural support for the gate or fence where the window is mounted.

12. The window for a gate from claim 1 that further is formed from a molding, stamping, casting or machining process.

13. The window for a gate from claim 1 that further includes fasteners for attaching the window to the gate or fence.

14. The window for a gate from claim 1 wherein the window is shaped like a house, square, rectangular, round, oval, polygonal, elliptical, pentagonal or hexagonal.

15. The window for a gate from claim 1 wherein the window is made from material selected from a group consisting of ABS, PVC, polycarbonate, polyethylene, Lexan, Acrylic, glass, plastic or resin.

16. The window for a gate from claim 1 that further includes suggested mounting heights for the window based upon the size of the pet that is found behind the fence or gate.

17. The window for a gate from claim 1 that allows for installation of two windows placed on opposite sides of the gate.

18. The window for a gate from claim 1 where the window material includes a colorant to provide color and or tinting of the transparent window.

19. The window for a gate from claim 2 wherein the printed, painted, embossed or molded cosmetic pattern exists on one or both sides of the window.

20. The window for a gate from claim 1 that further includes a method for installing the window that includes marking the gate or fence, removing material from the gate or fence, and installing the window on the gate or fence using fasteners.
